(19) United States
(12) Patent Application Publication
(10) Pub. No.: US 2006/0201359 A1
(43) Pub. Date: Sep. 14, 2006

(54) Anodization process of long-length aluminum plate, anodization apparatus and aluminum support for planographic printing plate material

(75) Inventor: Teruo Takada, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/371,016

(22) Filed: Mar. 9, 2006

(30) Foreign Application Priority Data
Mar. 14, 2005 (JP) JP2005-070721

(51) Int. Cl. B41N 3/00

(52) U.S. Cl. 101/467

(57) ABSTRACT

Disclosed is an anodization process of a long-length aluminum plate, employing an anodization apparatus comprising an electrolyte tank charged with an electrolytic solution, and provided in the electrolytic solution, an anode, a cathode and an electric insulator with an opening which forms a current flow section, the electric insulator being provided between the anode and the cathode, the process comprising the steps of providing a long-length aluminum plate between the cathode and the electric insulator in the electrolytic solution, and anodizing the long-length aluminum plate by supplying current between the anode and the long-length aluminum plate through the current flow section, whereby an anodization layer is formed on the aluminum plate surface on the side facing the cathode,
wherein 5(%)≦S(%)≦30(%) and 0.2≦T(mm)≦6×S^{-0.8}

This application is based on Japanese Patent Application No. 2005-070721, filed on Mar. 14, 2005 in Japanese Patent Office, the entire content of which is hereby incorporated by reference.

### FIELD OF THE INVENTION

The present invention relates to an anodization process of forming an anodization layer on the surface of a long-length aluminum plate, an anodization apparatus used in the anodization process, and an aluminum support for a planographic printing plate material manufactured according to the anodization process.

### BACKGROUND OF THE INVENTION

It is well known that an aluminum plate is used as a support for a planographic printing plate material. As the support for a planographic printing plate material is widely used an aluminum plate subjected to surface roughening treatment and anodization treatment, which provides good printing properties such as high water retention property or high printing durability.

As the anodization treatment above, there is a method in which a long length metal plate is electrolytically treated by allowing the metal plate to travel in an electrolytic solution in which an electrode is provided and supplying current between the running metal plate and the electrode facing one side of the metal plate surface, wherein an electric insulator plate is provided on the side of the metal plate opposite the electrode in the region where the electrolytic treatment is carried out (see Japanese Patent O.P.I. Publication No. 57-47894.), or a method in which an anodization layer is formed on a long-length aluminum plate in an electrolytic solution of an electrolyte tank comprising a first electrode, a second electrode and a mobile electric insulator provided between the electrodes, wherein when the aluminum plate travels between the first electrode and the electric insulator, which prevents current from flowing between the aluminum plate and the electric insulator, an anodization layer is formed only on the surface of the aluminum plate facing the first electrode, and when the aluminum plate travels between the first electrode and the electric insulator and the insulator is moved so that current flows between the aluminum plate and the second electrode, an anodization layer is formed on both surfaces of the aluminum plate (see Japanese Patent Publication No. 63-58233.).

Further, there is a method in which a long length sheet is provided between an anode and a cathode to form an anodization layer on the surface. For example, a method is known which employs a coil alumite one side processing apparatus employing direct current electrolysis, the apparatus comprising an electrolyte tank containing an electrolytic solution, an electricity supply electrode providing a (+) electricity and an electrolytic electrode provided with a (−) electricity each being opposed to each other in the electrolytic solution, two slit plates, a slit between the slit plates, a long-length sheet to be processed traveling between the both electrodes and then through the slit, and a U-shaped mask separator provided to cover the both edges in the transverse direction of the sheet, wherein the distance between the end on the sheet surface side of the slit plate and the sheet surface is not more than several millimeters, the distance between the wall of the U-shaped separator and the sheet surface is about 1 mm, and the distance between the wall of the U-shaped separator and the sheet end is not more than several millimeters, and wherein current for electrolysis flows in the thickness direction of the long length sheet (see Japanese Patent Publication No. 58-24517.).

However, these methods result in much loss of electricity, and effective anodization of an aluminum plate has been desired.

### SUMMARY OF THE INVENTION

An object of the invention is to provide an anodization process of a long-length aluminum plate, which reduces loss of electricity, to provide an anodization apparatus used in the anodization process, and to provide a support for a printing plate material manufactured according to the anodization process.

### BRIEF DESCRIPTION OF THE DRAWINGS

FIG. 1(a) shows a side view of one embodiment of the anodization apparatus of the invention.

FIG. 1(b) shows a sectional view of an electrolyte tank of the anodization apparatus.

FIG. 2 shows a plan view of the anodization apparatus

FIG. 3 shows a side view of one embodiment of conventional anodization apparatuses comprising an electricity supply tank.

FIG. 4(a) shows an embodiment of the shape of a current flow section provided in an electric insulator.

FIG. 4(b) shows another embodiment of the shape of a current flow section discontinuously provided in an electric insulator.

### DETAILED DESCRIPTION OF THE INVENTION

The above object has been attained by one of the following constitutions:

1. An anodization process of a long-length aluminum plate, employing an anodization apparatus comprising an electrolyte tank charged with an electrolytic solution, and provided in the electrolytic solution, an anode, a cathode and an electric insulator with an opening which forms a current flow section, the electric insulator being provided between the anode and the cathode, the process comprising the steps of (a) providing a long-length aluminum plate between the cathode and the electric insulator in the electrolytic solution, the opening of the electric insulator facing the position on the aluminum plate corresponding to a distance from both sides of the aluminum plate of 35% or more of the length in the transverse direction of the aluminum plate, and (b) anodizing the long-length aluminum plate by supplying current between the anode and the long-length aluminum plate through the current flow section, whereby an anodization layer is formed on the aluminum plate surface on the side facing the cathode,

wherein 5(%)≦S(%)≦30(%) and 0.2≦T(mm)≦6×S^{-0.8}, wherein S(%) represents the percentage of the area of the current flow section to that of the long-length aluminum plate, and T (mm) represents the distance between the long-length aluminum plate and the electric insulator.

2. The anodization process of item 1 above, wherein step (a) allows the long-length aluminum plate to travel in the long-length direction between the anode and the cathode, and the current flow section is a slit extending along the long-length direction.

3. The anodization process of item 2 above, wherein the width of the slit is from 5 to 30% of the width of the long-length aluminum plate.

4. The anodization process of item 3 above, wherein the width of the slit is from 7 to 20% of the width of the long-length aluminum plate.

5. The anodization process of item 2 above, wherein the traveling speed of the long-length aluminum plate is from 5 to 100 m/min.

6. The anodization process of item 1 above, wherein the amount of the formed anodization layer is from 1.5 to 4 g/m².

7. The anodization process of item 6 above, wherein the amount of the formed anodization layer is from 2 to 3 g/m².

8. The anodization process of item 1 above, wherein the distance between the long-length aluminum plate and the anode is from 40 to 60 mm.

9. The anodization process of item 1 above, wherein the thickness of the long-length aluminum plate is from 0.15 to 0.50 mm.

10. An anodization apparatus comprising an electrolyte tank charged with an electrolytic solution, and provided in the electrolytic solution, an anode, a cathode and an electric insulator with an opening which forms a current flow section, a long-length aluminum plate being provided between the cathode and the electric insulator, the opening of the electric insulator being provided so as to face the position on the aluminum plate corresponding to a distance from both sides of the aluminum plate of 35% or more of the length in the transverse direction of the aluminum plate to be provided between the cathode and the electric insulator, and the current flow section and the electric insulator being provided so that the following formulae are satisfied,
5(%)≦S(%)≦30(%) and 0.2≦T(mm)≦6×S^{0.8},
wherein S(%) represents the percentage of the area of the current flow section to that of the long-length aluminum plate, and T (mm) represents the distance between the long-length aluminum plate and the electric insulator.

The anodization process of the invention is a long-length aluminum plate anodization process employing an anodization apparatus comprising an electrolyte tank charged with an electrolytic solution, and provided in the electrolytic solution, an anode, a cathode and an electric insulator with an opening which forms a current flow section, the electric insulator being provided between the anode and the cathode, the process comprising the steps of (a) providing a long-length aluminum plate between the cathode and the electric insulator in the electrolytic solution, the opening of the electric insulator facing the position on the aluminum plate corresponding to a distance from both sides of the aluminum plate of 35% or more of the length in the transverse direction of the aluminum plate, and (b) anodizing the long-length aluminum plate by supplying current between the anode and the long-length aluminum plate through the current flow section, whereby an anodization layer is formed on the aluminum plate surface on the side facing the cathode, wherein 5(%)≦S(%)≦30(%) and 0.2≦T(mm)≦6×S^{0.8}, wherein S(%) represents the percentage of the area of the current flow section to that of the long-length aluminum plate, and T (mm) represents the distance between the long-length aluminum plate and the electric insulator.

(Long-Length Aluminum Plate)

The aluminum plate used in the invention is a long-length aluminum plate, and materials thereof may be pure aluminum or aluminum alloy. As the aluminum alloy, there can be used various ones including an alloy of aluminum and a metal such as silicon, copper, manganese, magnesium, chromium, zinc, lead, bismuth, nickel, titanium, sodium or iron. Further, an aluminum plate manufactured by rolling can be used. A regenerated aluminum plate obtained by rolling aluminum regenerated from scrapped or recycled materials, which has recently spread, can be also used.

(Anodization)

Surface-roughening (graining) of a long-length aluminum plate is preferably carried out prior to anodization in the invention. It is preferable that the aluminum plate is subjected to degreasing treatment for removing rolling oil prior to surface-roughening (graining).

The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting plate is preferably subjected to desmut treatment in an aqueous solution of an acid such as phosphoric acid, nitric acid, sulfuric acid, chromic acid, or a mixture thereof, since smut is produced on the surface.

Subsequently, surface-roughening treatment is carried out. As the surface-roughening treatment, there are, for example, mechanical surface-roughening treatment and electrolytic surface-roughening treatment in an electrolyte solution containing hydrochloric acid or nitric acid as a main component.

Though there is no restriction for the mechanical surface-roughening method, a brushing roughening method and a honing roughening method are preferable. The brushing roughening method is carried out by rubbing the surface of the plate with a rotating brush with a brush hair with a diameter of 0.2 to 0.8 mm, while supplying slurry in which volcanic ash particles with a particle size of 10 to 100 μm are dispersed in water to the surface of the plate. The honing roughening method is carried out by ejecting obliquely slurry with pressure applied from nozzles to the surface of the plate, the slurry containing volcanic ash particles with a particle size of 10 to 100 μm dispersed in water. Surface-roughening can be also carried out by laminating the plate surface with a sheet on the surface of which abrading particles with a particle size of from 10 to 100 μm has been coated at intervals of 100 to 200 μm and at a density of 2.5 ×10³ to 10×10³/cm², and then applying pressure to the laminated sheet to transfer the roughened pattern of the sheet, whereby the plate surface is roughened.

After the plate has been roughened mechanically, it is preferably dipped in an acid or an aqueous alkali solution in order to remove abrasives and aluminum dust, etc. which have been embedded in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous solution of alkali chemicals such as sodium hydroxide is preferably used. The dissolution amount of aluminum in the plate surface is preferably 0.5 to 5 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

In the electrolytic surface-roughening treatment carried out in the electrolytic solution (hereinafter also referred to as nitric acid electrolytic solution) containing nitric acid, voltage applied is generally from 1 to 50 V, and preferably from 10 to 30 V. The current density used can be selected from the range from 10 to 200 A/dm², and is preferably from 20 to 100 A/dm². The quantity of electricity can be selected from the range of from 100 to 2000 C/dm², and is preferably 300 to 1500 C/dm². The temperature during the electrolytic surface-roughening treatment may be in the range of from 10 to 50° C., and is preferably from 15 to 45° C. The nitric acid concentration in the nitric acid electrolytic solution is preferably from 0.1 to 5% by weight. It is possible to optionally add, to the nitric acid electrolytic solution, nitrates, chlorides, amines, aldehydes, phosphoric acid, chromic acid, boric acid, acetic acid, oxalic acid or aluminum salts.

After the aluminum plate has been subjected to electrolytic surface-roughening treatment in the nitric acid electrolytic solution, it is preferably dipped in an acid or an aqueous alkali solution in order to remove abrasives and aluminum dust, etc., which have been produced in the plate surface. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous alkali solution of for example, sodium hydroxide is preferably used. The dissolution amount of aluminum in the plate surface is preferably 0.1 to 2 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

In electrolytic surface-roughening treatment carried out in the electrolytic solution containing hydrochloric acid (hereinafter also referred to as hydrochloric acid electrolytic solution), the hydrochloric acid concentration in the hydrochloric acid electrolytic solution is from 5 to 20 g/liter, and preferably from 6 to 15 g/liter. The current density supplied is in the range from 15 to 200 A/dm², and preferably from 20 to 150 A/dm². The quantity of electricity is in the range of from 400 to 2000 C/dm², and preferably 500 to 1500 C/dm². Frequency is preferably in the range of from 40 to 150 Hz. The temperature during the electrolytic surface-roughening treatment may be in the range of from 10 to 50°. C, and is preferably from 15 to 45° C. It is possible to optionally add, to the hydrochloric acid electrolytic solution, nitrates, chlorides, amines, aldehydes, phosphoric acid, chromic acid, boric acid, acetic acid, oxalic acid or aluminum salts.

After the aluminum plate has been subjected to electrolytic surface-roughening treatment in the hydrochloric acid electrolytic solution, it is preferably dipped in an acid or an aqueous alkali solution in order to remove aluminum dust, etc., which have been produced in the plate surface. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, a phosphoric acid or sodium hydroxide aqueous solution is preferably used. The dissolution amount of aluminum in the plate surface is preferably 0.1 to 2 g/m²; After the plate has been dipped in the aqueous alkali solution, it is preferable for the plate to be dipped in an acid such as phosphoric acid, nitric acid, sulfuric acid and chromic acid, or in a mixed acid thereof, for neutralization.

The average surface roughness (Ra) of the surface-roughened aluminum plate is preferably from 0.3 to 0.8 μm. The average surface roughness can be adjusted by appropriately selecting surface roughening conditions such as concentration of the electrolytic solution used, current density supplied or electricity supplied.

The anodization process of the invention is preferably carried out after the surface-roughening treatment described above.

The anodization process of the invention will be explained below employing figures.

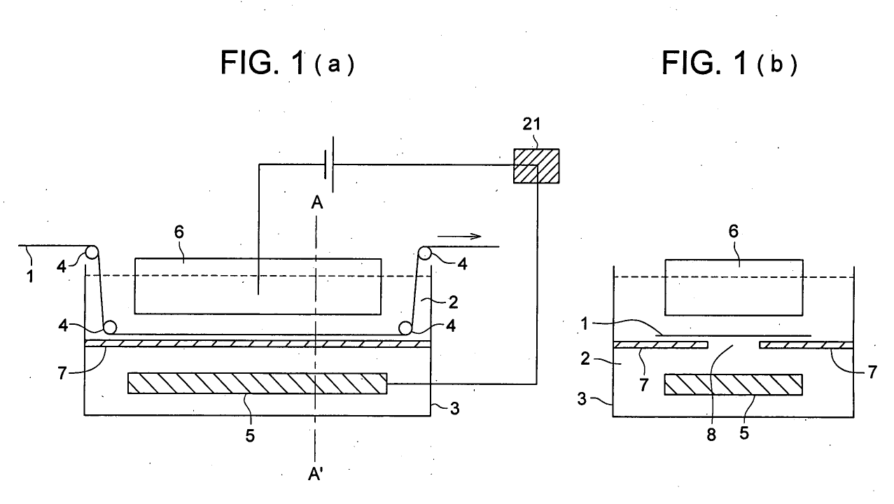

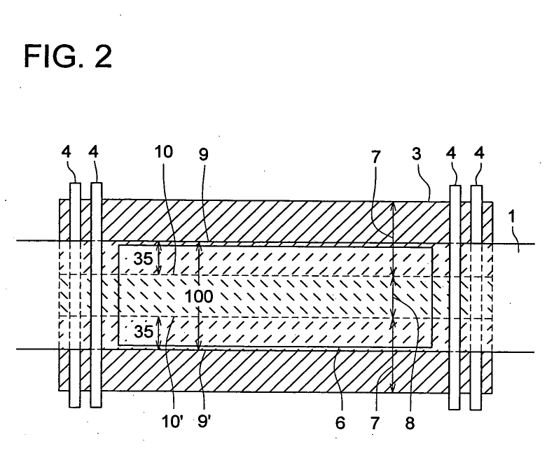

FIG. 1(a) shows a side view of one embodiment of the anodization apparatus of the invention. FIG. 1(b) shows a sectional view of an electrolyte tank of the anodization apparatus, which is taken on line A-A′ of FIG. 1(a). The electrolyte tank of the anodization apparatus is used in examples described later. FIG. 2 shows a plan view of the anodization apparatus (in which an electrolytic solution 2 is not illustrated).

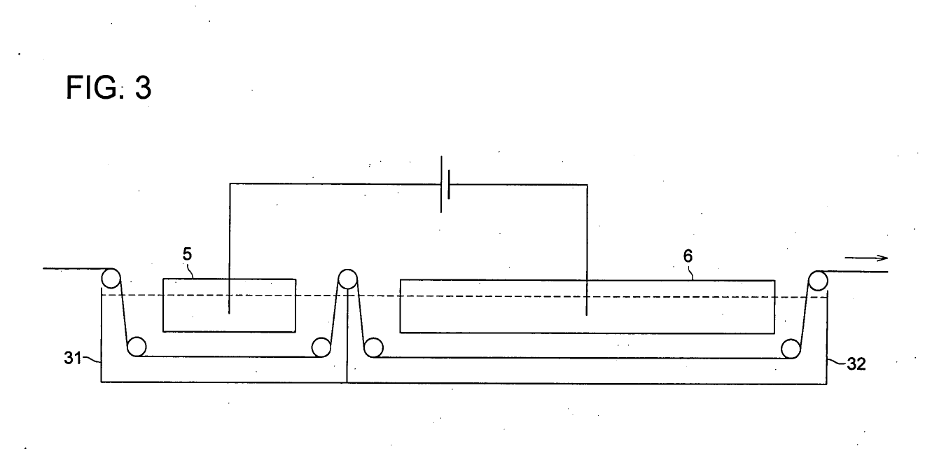

FIG. 3 shows a side view of one embodiment of conventional anodization apparatuses comprising an electricity supply tank (equipped with an anode).

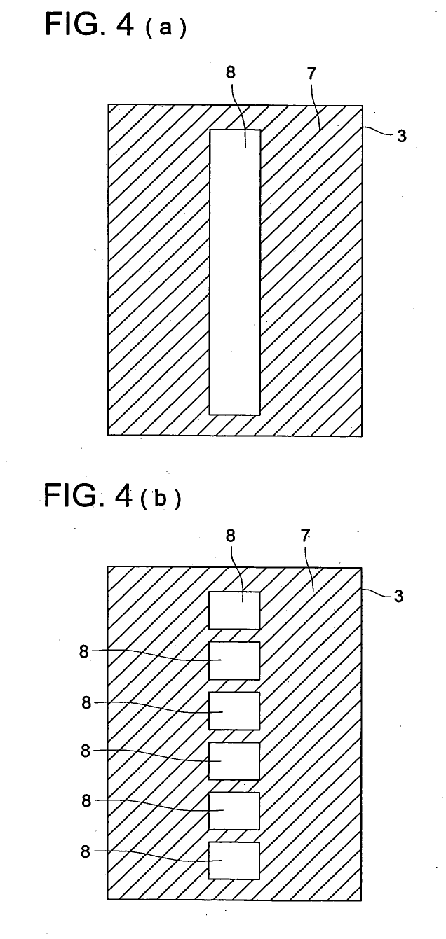

FIG. 4 shows an embodiment of the shape of an electric insulator.

In FIGS. 1(a) and 1(b), long-length aluminum plate 1 is allowed to travel in electrolyte tank 3 charged with electrolytic solution 2 through rollers 4, and anodized. The long-length aluminum plate 1 is allowed to travel between anode 5 and cathode 6 in the electrolytic solution 2.

Electric insulator 7 with current flow section 8 as shown in FIG. 1(b) is provided between the long-length aluminum plate 1 and the anode 5. The current flow section in the invention refers to an opening provided in an electric insulator.

When voltage is applied between the anode 5 and the cathode 6, current flows, through the current flow section 8, from the anode 5 to the long-length aluminum plate 1, and then flows from the long-length aluminum plate 1 to the cathode 6, whereby an anodization layer is formed on the surface on the side facing the cathode 6 of the long-length aluminum plate 1. Voltage is applied through electricity supply apparatus 21.

The current flow section 8 faces a position on the long-length aluminum plate 1 corresponding to a distance from both sides of the aluminum plate of 35% or more of the length in the transverse direction of the long-length aluminum plate.

As shown in FIG. 2, the both sides refer to positions 9 and 9′ corresponding to the both ends in the transverse direction of the long-length aluminum plate 1.

As is shown in FIG. 2, the position on the long-length aluminum plate corresponding to a distance from both sides of the aluminum plate of 35% (the length 35) or more of the length (width 100) in the transverse direction of the long-length aluminum plate refers to a position between positions 10 and 10′, the distance between positions 10 and 9 and the distance between positions 10′ and 9′ is 35% of the length in the transverse direction of the long-length aluminum plate, respectively.

The current flow section 8, i.e., an opening provided in the electric insulator 7, is preferably a slit-shaped opening extending along the long-length direction. The width of the slit-shaped opening is preferably from 5 to 30%, and more preferably from 7 to 20%, of the width of the long-length aluminum plate 1.

In the invention, the following inequalities is satisfied,
5(%)≦S(%)≦30(%) and 0.2≦T(mm)≦6×S^{0.8},
wherein S(%) represents a percentage of the area of the current flow section to that of the long-length aluminum plate, and T (mm) represents a distance between the long-length aluminum plate and the electric insulator.

The S(%) refers to percentage of the area of the current flow section to the sum of the area of the electric insulator facing the long-length aluminum plate and the area of the current flow section.

It is preferred that one end of the electric insulator 7 contacts the wall of the electrolyte tank. That is, the electrolytic solution on the anode side and the electrolytic solution on the cathode side preferably combine with each other only through the current flow section. In FIG. 2, numerical number 4 represents a roller, and numerical number 6 represents a cathode.

The distance between the long-length aluminum plate and the anode is preferably from 20 to 100 mm, and more preferably from 40 to 60 mm, in reducing loss of electric power.

In the invention, the thickness of the long-length aluminum plate is preferably from 0.15 to 0.5 mm. The current density to be supplied onto the surface (on the side of which an anodization layer is to be formed) of the long-length aluminum plate is preferably from 500 to 10000 A/m².

The traveling speed of the long-length aluminum plate is preferably from 5 to 100 m/min, and more preferably from 10 to 80 m/min.

In the invention, the shape of the current flow section, i.e., the shape of the opening in the electric insulator, may be a slit 8 surrounded by straight lines provided in the electric insulator 7 (as shown in FIG. 4(a)), slits surrounded by straight lines discontinuously provided in the electric insulator 7 (as shown in FIG. 4(b)), slits surrounded by curves, holes discontinuously provided in the electric insulator, or holes in the network form. In FIGS. 4(a) and 4(b), numerical number 3 represents an electrolyte tank, numerical number 7 an electric insulator, and numerical number 8 a current flow section.

The electric insulator in the invention refers to an insulator having a volume resistance of not less than 10¹⁵Ω. Examples thereof include a film of acryl resin, polyvinyl chloride, polypropylene, polybutylene, polyethylene, and polystyrene. Polyvinyl chloride film or polypropylene film, each having high strength, is preferably employed.

It is more effective in the invention that plural electrolyte tanks are continuously provided.

Current density flowing through the current flow section is preferably from 500 to 60000 A/m².

A titanium mesh or a platinum mesh can be used as material for the anode, and carbon or aluminum can be used as material for the cathode. The anode need not be one body. For example, it is preferred that many anodes having a length of 50 to 200 mm are provided so that hydrogen gas, etc. does not accumulate at spaces between them.

FIG. 3 shows a side view of one embodiment of conventional anodization apparatuses. In FIG. 3, an electricity supply tank 31 containing anode 5 is provided upstream an electrolytic tank 32 containing a cathode 6. As anodization speed becomes high, much current is necessary where it is necessary to provide two or three power supplies separately and lengthen the cathode. However, length of anodization process is restricted as anodization speed becomes high, since an aluminum plate to be anodized works as a resistance and current may be difficult to flow.

The electrolytic solution for the anodization process of the invention is preferably a sulfuric acid solution or an electrolytic solution containing sulfuric acid mainly (hereinafter also referred to as sulfuric acid electrolytic solution). The sulfuric acid content of the sulfuric acid electrolytic solution is preferably from 5 to 50% by weight, and more preferably from 15 to 35% by weight. The temperature of the sulfuric acid electrolytic solution is preferably from 10 to 50° C.

Voltage applied during anodization is preferably not less than 18V, and more preferably not less than 20V.

The amount of the anodization layer formed on the aluminum plate is preferably from 1.5 to 4 g/m², and more preferably from 2 to 3 g/m². The amount of the formed anodization layer can be obtained from the weight difference between the aluminum plates before and after dissolution of the anodization layer. The anodization layer of the aluminum plate is dissolved by being immersed at 90° C. for 5 minutes in for example, an aqueous phosphoric acid chromic acid solution, which is prepared by dissolving 35 ml of 85% by weight phosphoric acid and 20 g of chromium (IV) oxide in 1 liter of water.

Micro pores are formed in the anodization layer. The micro pore density in the anodization layer is preferably from 400 to 700/μm², and more preferably from 400 to 600/μm².

The aluminum plate, which has been subjected to anodization treatment, is optionally subjected to sealing treatment. For the sealing treatment, it is possible to use known methods using hot water, boiling water, steam, a sodium silicate solution, an aqueous dichromate solution, a nitrite solution, an ammonium acetate solution or polyvinyl phosphonic acid solution.

The anodization process of the invention can be carried out employing an anodization apparatus comprising the electrolyte tank as described above and a means for supplying electricity to the electrolyte tank.

In the invention, a light sensitive planographic printing plate material can be prepared by providing a light sensitive layer on the support of the invention in which an aluminum plate has been subjected to anodization.

The light sensitive layer herein is a layer which is capable of forming an image after imagewise exposure. As such a light sensitive layer, a negative or positive working light sensitive layer, which has been used for a light sensitive layer of PS plates, can be employed.

(Positive Working Light Sensitive Layer)

As a compound used in the positive working light sensitive layer, there are o-naphthoquinonediazide compounds. As the o-naphthoquinonediazide compound, ester of 1,2-diazonaphthoquinone sulfonic acid and pyrogallol-acetone resin is preferred which is disclosed in Japanese Patent Publication No. 43-28403. Other preferred examples thereof include ester of 1,2-diazonaphthoquinone-5-sulfonic acid and phenol-formaldehyde resin as disclosed in U.S. Pat. Nos. 3,046,120 and 3,188,210, and ester of 1,2 diazonaphthoquinone-4-sulfonic acid and phenol-formaldehyde resin as disclosed in Japanese Patent O.P.I. Publication Nos. 2-96163, 2-96165, and 2-96761. As other useful o-naphthoquinonediazide compounds, there are various o-naphthoquinonediazide compounds disclosed in many patent documents, for example, in Japanese Patent O.P.I. Publication Nos. 47-5303, 48-63802, 48-63803, 48-96575, 49-38701, and 48-13854; Japanese Patent Publication Nos. 37-18015, 41-11222, 45-9610, and 49-17481; U.S. Pat. Nos. 2,797,212, 3,454,400, 3,544,323, 3,573,917, 3,674,495, and 3,785,825; British Patent Nos. 1,227,602, 1,251,345, 1,267,005, and 1,329,888; and German Patent No. 854,890.

The o-quinonediazide compounds may be used alone, but is preferably used in combination with an alkali soluble resin (binder). As such an alkali soluble resin, there are novolak resins, typically, phenol-formaldehyde resin, o-, m- or p-cresol-formaldehyde resin, and phenol/cresol (o-, m- or p-cresol, or m/p- or o/m-mixed cresol)-formaldehyde resin. Other examples of the o-quinonediazide compounds include phenol-modified xylene resin, poly(hydroxystyrene), poly(halogenated hydroxystyrene), and acryl resins having a hydroxyl group as disclosed in Japanese Patent O.P.I. Publication No. 51-34711. As the preferred binder, there are copolymers with a molecular weight of from 10,000 to 200,000 having a unit from the monomers as shown in (1) through (12) above and a unit from unsaturated carboxylic acids such as (13) acrylic acid, methacrylic acid, maleic acid anhydride, and itaconic acid.

In order to increase stability (so-called developing latitude) under various developing conditions, the positive working light sensitive layer can contain non-ionic surfactants as disclosed in Japanese Patent O.P.I. Publication Nos. 62-251740 and 2-96760 or amphoteric surfactants as disclosed in Japanese Patent O.P.I. Publication Nos. 59-121044 and 4-13149.

Examples of the non-ionic surfactants include sorbitan tristearate, sorbitan monopalmitate, sorbitan trioleate, stearic acid monoglyceride, polyoxyethylene sorbitan monooleate, and polyoxyethylene nonylphenyl ether. Examples of the amphoteric surfactants include alkyldi(aminoethyl)-glycine, alkylpoly(aminoethyl)glycine hydrochloride, 2-alkyl-N-carboxyethyl-N-hydroxyethylimidazolinium betaine, N-tetradecyl-N,N-betaine type compounds (for example, trade name: AMOGEN K produced by DAIICHI KOGYO CO., LTD.) and alkylimidazoline type compounds (for example, REBON 15 produced by SANYO CHEMICAL CO., LTD.). The content in the light sensitive layer of the non-ionic surfactants or amphoteric surfactants is preferably from 0.05 to 15% by weight, and more preferably from 0.1 to 5% by weight.

To the positive working light sensitive layer can be added a print-out agent for obtaining a visible image immediately after imagewise exposure or a dye or pigment as an image coloration agent.

Representative examples of the print-out agent are combinations of compounds releasing an acid on exposure (photolytically acid-releasing agent) and organic dyes capable of forming a salt. Specific examples of the combination include a combination of o-naphthoquinonediazide-4-sulfonic acid halide and a salt-forming organic dye described in JP-A Nos. 50-36209 and 53-8128, and a combination of a trihalomethyl compound and a salt-forming organic dye described in JP-A Nos. 53-36223, 54-74728, 60-3626, 61-143748, 61-151644 and 63-58440. Examples of the trihalomethyl compound include oxazole-based compounds and triazine-based compounds, and any of these is excellent in stability over time and gives a clear print-out image. As the image coloration agent, other dyes are also used other than the above-mentioned salt-forming organic dyes. Examples of the suitable dye include oil-soluble dyes and basic dyes in addition to the salt-forming organic dyes. Specific examples thereof include Oil Yellow #101, Oil Yellow #103, Oil Pink #312, Oil green BG, Oil Blue BOS, Oil Blue #603, Oil Black BY, Oil Black BS, Oil Black T-505 (all of these are manufactured by Orient Chemical Industries, Ltd.), Victoria Pure Blue, Crystal Violet (CI42555), Methyl Violet (CI42535), Ethyl Violet, Rhodamine B (CI145170B), Malachite Green (CI42000) and Methylene Blue (CI52015). Particularly preferable dyes are those described in JP-A No. 62-293247.

(Negative Working Light Sensitive Layer)

As the negative working light sensitive layer, there are a light sensitive layer containing a light sensitive diazo compound, a photopolymerizable light sensitive layer and a photo-crosslinking containing light sensitive layer.

As the light sensitive diazo compound is suitably used a diazo resin prepared by condensing an aromatic diazonium compound with a active carbonyl group-containing organic condensation agent, particularly aldehydes such as formaldehyde or acetaldehyde or acetals in an acidic medium. Typical examples thereof include a condensation product of p-diazophenylamine with formaldehyde. The synthetic method of these diazo resins is described in U.S. Pat. Nos. 2,679,498, 3,050,502, 3,311,605, and 3,277,074. The light sensitive diazo compound preferably is a co-condensation diazo compound comprising in the molecule an aromatic diazonium salt unit and a substituted aromatic compound unit containing no diazonium group described in Japanese Patent Publication No. 49-48001, and more preferably a co-condensation diazo compound comprising in the molecule an aromatic diazonium salt unit and an aromatic compound unit having an alkali-solubilizing group such as a carboxyl group or a hydroxyl group.

The light sensitive layer in the invention can contain the surfactant as denoted above in the positive working light sensitive layer in order to improve quality of the coated layer surface.

(Matting Agent)

A matting layer may be provided on the light sensitive layer in order to prevent blurring on exposure and shorten vacuum drawing time when contact exposure under vacuum is carried out.

As the light sensitive layer of the light sensitive planographic printing plate material of the invention, a thermosensitive image formation layer can be employed which is used in a processless planographic printing plate material which requires no developing treatment.

The light sensitive planographic printing plate material comprising the support of the invention is imagewise exposed and optionally subjected to developing treatment to obtain a planographic printing plate.

### EXAMPLES

Next, the present invention will be explained employing examples, but the present invention is not limited thereto. In the examples, “parts” represents “parts by weight”, unless otherwise specified.

(Preparation of Supports 1 Through 9)

Employing a continuous aluminum plate processing apparatus, a 0.24 mm thick aluminum (according to JIS 1050) plate with a width of 1000 mm) was degreased at 60° C. for 10 seconds in a 5% sodium hydroxide solution, washed with water, immersed at 25° C. for 10 seconds in a 10% nitric acid solution to neutralize, and then washed with water. The aluminum plate was electrolytically surface-roughened at 30° C. for 10 seconds at a current density of 8 kA/m² in an aqueous solution containing 11 g/liter of hydrochloric acid, and 1.5 g/liter of dissolved aluminum, immersed in a 1% sodium hydroxide solution at 20° C. for 10 seconds, further immersed in a 10% nitric acid solution at 25° C. for 10 seconds to neutralize, and then washed with water.

The electrolytically surface-roughened aluminum plate was anodized at electrolytic conditions as shown in Table 1, employing two (first electrolyte tank and second electrolyte tank) of an electrolyte tank (electrolytic processing length: 3 m) equipped with an electric insulator having a slit-shaped opening (hereinafter also referred to as the slit) shown in FIG. 1. Herein, the electrolytically surface-roughened aluminum plate was passed through the first tank and then through the second tank, electric power being supplied to each tank.

The electrolytic voltage applied for the anodization is shown in Table 1.

The anodization was carried out at 30° C. in an aqueous 210 g/liter sulfuric acid solution.

The area of the current flow section was adjusted by varying the opening width of the electric insulator a current flow section. The anodization was carried our at a percentage S (%) of an area of the current flow section to that of the long-length aluminum plate, and a distance T (mm) between the long-length aluminum plate and the electric insulator, each being in shown in Table 1.

A distance between the long-length aluminum plate and the anode was 50 mm.

Successively, the anodized aluminum plate was washed with water, immersed in an aqueous 0.2% polyvinyl phosphonic acid at 70° C. for 30 minutes for hydrophilization treatment, and washed with water. Thus, supports 1 through 8 were obtained.

Further, the electrolytically surface-roughened aluminum plate was anodized at electrolytic conditions as shown in Table 1, employing an electrolyte tank (electrolytic processing length: 6 m) shown in FIG. 3, wherein the anodization was carried out at 30° C. in an aqueous 210 g/liter sulfuric acid solution. The resulting anodized plate was processed in the same manner as in supports 1 through 8 above. Thus, support 9 was obtained.

The amount of the anodization layer of the supports is shown in Table 1.

(Preparation of Positive Working Light Sensitive Planographic Printing Plate Material)

The following positive light sensitive layer composition was coated on each of the supports 1 through 9 obtained above to prepare a light sensitive planographic printing plate material sample.

(Positive Working Light Sensitive Layer Composition)

| | |
|---|---|
| Condensation product | 5 parts |
| (esterification rate: 20%) of a pyrogallol-acetone resin | |
| (*Mw: 2,500) with naphthoquinone(1,2)-diazide-(2)-5- | |
| sulfonylchloride | |
| Novolak resin (*Mw: 5,500): condensation | 20 parts |
| product of mixed phenols (phenol/m-cresol/p-cresol, | |
| 5/57/38, weight ratio) and formaldehyde | |
| Esterification product | 0.25 parts |
| (esterification rate: 50%) of naphthoquinone(1,2)-diazide- | |
| (2)-5-sulfonylchloride and p-tert-octylphenol-formaldehyde | |
| novolak resin (*Mw: 1,800) | |
| 3,4-Dimethoxybenzoic acid | 1.25 parts |
| 2-Trichloromethyl-5-[b-(2-benzofuryl)vinyl]- | 0.25 parts |
| 1,3,4-oxadiazole | |
| Bictoria Pure Blue BOH (made by Hodogaya | 0.25 parts |
| Kagaku Co., Ltd.) | |
| Methyl cellosolve | 200 parts |

The resulting light sensitive planographic printing plate material sample was imagewise exposed and developed to prepare a planographic printing plate. Employing the planographic printing plate, printing was carried out and printed matter with good image quality was obtained.

TABLE 1

| | | | First | | Second | | | | |
|---|---|---|---|---|---|---|---|---|---|
| | | | electrolytic | | electrolytic | | | | |
| | | | tank | | tank | | Total | | |
| Sup- | | | Current | Voltage | Current | Voltage | power | Amount of | |
| port | T | S | supplied | applied | supplied | applied | supplied | anodization | Re- |
| No. | (mm) | (%) | (A) | (V) | (A) | (V) | (kW) | layer (g/m²) | marks |
| 1 | 1.0 | 7 | 8400 | 30 | 8400 | 31 | 512 | 2.50 | Inv. |
| 2 | 0.5 | 20 | 8900 | 31 | 8900 | 32 | 560 | 2.50 | Inv. |
| 3 | 0.2 | 30 | 8200 | 31 | 8200 | 32 | 517 | 2.50 | Inv. |
| 4 | 1.0 | 10 | 10000 | 29 | 10000 | 30 | 590 | 2.50 | Comp. |
| 5 | 0.5 | 30 | 11000 | 28 | 11000 | 29 | 627 | 2.50 | Comp. |
| 6 | 1.6 | 7 | 13000 | 26 | 13000 | 27 | 689 | 2.50 | Comp. |
| 7 | 1.0 | 20 | 15000 | 25 | 15000 | 26 | 765 | 2.50 | Comp. |
| 8 | 0.2 | 35 | 10500 | 28 | 10500 | 29 | 599 | 2.50 | Comp. |
| 9 | — | — | 16000 | 37 | — | — | 592 | 2.50 | Comp. |

Inv.: Inventive, Comp.: Comparative

As is apparent from Table 1 above, the anodization process according to the invention can form an anodization layer on the aluminum plate surface with reduced loss of electricity.

What is claimed is:

1. An anodization process of a long-length aluminum plate, employing an anodization apparatus comprising an electrolyte tank charged with an electrolytic solution, and provided in the electrolytic solution, an anode, a cathode and an electric insulator with an opening which forms a current flow section, the electric insulator being provided between the anode and the cathode, the process comprising the steps of:
(a) providing a long-length aluminum plate between the cathode and the electric insulator in the electrolytic solution, the opening of the electric insulator facing the position on the aluminum plate corresponding to a distance from both sides of the aluminum plate of 35% or more of the length in the transverse direction of the aluminum plate; and
(b) anodizing the long-length aluminum plate by supplying current between the anode and the long-length aluminum plate through the current flow section, whereby an anodization layer is formed on the aluminum plate surface on the side facing the cathode,
wherein 5(%)≦S(%)≦30(%) and 0.2≦T(mm)≦6×S^{-0.8}, wherein S(%) represents the percentage of the area of the current flow section to that of the long-length aluminum plate, and T (mm) represents the distance between the long-length aluminum plate and the electric insulator.

2. The anodization process of claim 1, wherein step (a) allows the long-length aluminum plate to travel in the long-length direction between the anode and the cathode, and the current flow section is a slit extending along the long-length direction of the aluminum plate.

3. The anodization process of claim 2, wherein the width of the slit is from 5 to 30% of the width of the long-length aluminum plate.

4. The anodization process of claim 3, wherein the width of the slit is from 7 to 20% of the width of the long-length aluminum plate.

5. The anodization process of claim 2, wherein the traveling speed of the long-length aluminum plate is from 5 to 100 m/min.

6. The anodization process of claim 1, wherein the amount of the formed anodization layer is from 1.5 to 4 g/m².

7. The anodization process of claim 6, wherein the amount of the formed anodization layer is from 2 to 3 g/m².

8. The anodization process of claim 1, wherein the distance between the long-length aluminum plate and the anode is from 40 to 60 mm.

9. The anodization process of claim 1, wherein the thickness of the long-length aluminum plate is from 0.15 to 0.50 mm.

10. An anodization apparatus comprising an electrolyte tank charged with an electrolytic solution, and provided in the electrolytic solution, an anode, a cathode and an electric insulator with an opening which forms a current flow section, a long-length aluminum plate being provided between the cathode and the electric insulator, the opening of the electric insulator being provided so as to face the position on the aluminum plate corresponding to a distance from both sides of the aluminum plate of 35% or more of the length in the transverse direction of the aluminum plate to be provided between the cathode and the electric insulator, and the current flow section and the electric insulator being provided so that the following formulae are satisfied,
5(%)≦S(%)≦30(%) and 0.2≦T(mm)≦6×S^{-0.8},
wherein S(%) represents the percentage of the area of the current flow section to that of the long-length aluminum plate, and T (mm) represents the distance between the long-length aluminum plate and the electric insulator.
